(19) United States
(12) Patent Application Publication
(10) Pub. No.: US 2024/0387806 A1
(43) Pub. Date: Nov. 21, 2024

(54) SURFACE-MODIFIED NEGATIVE ELECTRODE ACTIVE MATERIAL PARTICLE, NEGATIVE ELECTRODE MIXTURE, LITHIUM-ION BATTERY, AND METHOD FOR PRODUCING NEGATIVE ELECTRODE MIXTURE

(71) Applicant: Toyota Jidosha Kabushiki Kaisha, Toyota-shi (JP)

(72) Inventor: Azusa NAKANISHI, Susono-shi (JP)

(73) Assignee: TOYOTA JIDOSHA KABUSHIKI KAISHA, Toyota-shi (JP)

(21) Appl. No.: 18/595,770

(22) Filed: Mar. 5, 2024

(30) Foreign Application Priority Data
May 16, 2023 (JP) 2023-080827

(51) Int. Cl. H01M 4/38; H01M 4/02; H01M 4/62; H01M 10/0525

(52) U.S. Cl. CPC H01M 4/386; H01M 4/623; H01M 10/0525; H01M 2004/027

(57) ABSTRACT

The surface-modified negative electrode active material particles of the present disclosure have silicon particles and a fluoroalkyl group that modifies the surface of the silicon particles. The negative electrode mixture of the present disclosure includes surface-modified negative electrode active material particles and a fluorine-containing binder. The surface-modified negative electrode active material particles included in the negative electrode mixture of the present disclosure have silicon particles and a fluoroalkyl group that modifies the surface of the silicon particles. The lithium-ion battery of the present disclosure has a negative electrode active material layer containing a negative electrode mixture. The method of the present disclosure for producing surface-modified negative electrode active material particles includes modifying the surface of the silicon particles with fluoroalkyl groups.

### CROSS-REFERENCE TO RELATED APPLICATION

This application claims priority to Japanese Patent Application No. 2023-080827 filed on May 16, 2023, incorporated herein by reference in its entirety.

### BACKGROUND

### 1. Technical Field

The present disclosure relates to surface-modified negative electrode active material particles, negative electrode mixtures, lithium-ion batteries, and methods for producing a negative electrode mixture.

### 2. Description of Related Art

In recent years, batteries have been actively developed. For example, batteries for use in battery electric vehicles or hybrid electric vehicles have been developed in the automotive industry. Silicon is known as a negative electrode active material for use in batteries.

Japanese Unexamined Patent Application Publication No. 2018-120866 (JP 2018-120866 A) discloses a negative electrode active material. The negative electrode active material is characterized in that the negative electrode active material includes a carbon-based negative electrode active material and porous SiOₓ particles (0≤x<2), the porous SiOₓ particle includes an oxide film layer coating its surface, the porous SiOₓ particle is a porous silicon particle, the thickness of the oxide film layer is 40 nm or more and 200 nm or less, and the specific surface area of the porous SiOₓ particle is 5 m²/g to 50 m²/g.

### SUMMARY

It is desired to reduce the resistance of lithium-ion batteries.

It is an object of the present disclosure to provide a surface-modified negative electrode active material particle having low resistance, a negative electrode mixture containing such a surface-modified negative electrode active material particle, a lithium-ion battery including such a surface-modified negative electrode active material particle, and a method for producing such a surface-modified negative electrode active material particle.

The discloser etc. of the present disclosure found that the above problem can be solved by the following means.

### First Aspect

A surface-modified negative electrode active material particle including:
a silicon particle; and
a fluoroalkyl group modifying a surface of the silicon particle.

### Second Aspect

The surface-modified negative electrode active material particle according to the first aspect, wherein the surface-modified negative electrode active material particle includes a silicon-oxygen-silicon-carbon bond, the silicon not bonded to the carbon is silicon of the silicon particle, and the carbon is carbon of the fluoroalkyl group.

### Third Aspect

The surface-modified negative electrode active material particle according to the first aspect, wherein a carbon number of the fluoroalkyl group is 3 or more and 12 or less.

### Fourth Aspect

A negative electrode mixture, including:
the surface-modified negative electrode active material particle according to any one of the first to third aspects; and
a fluorine-containing binder.

### Fifth Aspect

The negative electrode mixture according to the fourth aspect, wherein the fluorine-containing binder is a polyvinylidene fluoride-based binder.

### Sixth Aspect

A lithium-ion battery, including
a negative electrode active material layer, wherein
the negative electrode active material layer contains the negative electrode mixture according to the fourth or fifth aspect.

### Seventh Aspect

A method for producing a surface-modified negative electrode active material particle, the method including
modifying a surface of a silicon particle with a fluoroalkyl group.

### Eighth Aspect

The method according to the seventh aspect, wherein the surface of the silicon particle is modified with the fluoroalkyl group by dehydration condensation between a silanol group on the surface of the silicon particle and a silanol group generated by hydrolyzing hydrolyzable group-containing silane having a fluoroalkyl group.

According to the present disclosure, it is possible to provide a surface-modified negative electrode active material particle having low resistance, a negative electrode mixture containing such a surface-modified negative electrode active material particle, a lithium-ion battery including such a surface-modified negative electrode active material particle, and a method for producing such a surface-modified negative electrode active material particle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is XPS of Comparative Synthetic Examples 1 to 3 and Synthetic Examples 1 and 2 (Si(2p)); and

FIG. 2 shows XPS measurements (F(1s)) of Comparative Synthesis Examples 1 to 3 and Synthesis Examples 1 and 2.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Surface-Modified Negative Electrode Active Material Particles

The surface-modified negative electrode active material particles of the present disclosure have silicon particles and a fluoroalkyl group that modifies the surface of the silicon particles.

The inventors of the present disclosure have found that a lithium-ion battery including silicon particles having a surface modified with a fluoroalkyl group as a negative electrode active material has low resistance. The reason for this is not intended to be bound by any theory, but is presumed as follows: That is, it is considered that the affinity between the silicon particles and the fluorine-containing binder in the negative electrode mixture is improved by modifying the surface of the silicon particles. The battery manufactured using the negative electrode mixture is likely to be uniformly charged, and thus the resistance is considered to be reduced.

### Silicon Particle

The surface-modified negative electrode active material particles of the present disclosure include silicon particles.

The composition of the silicon particles is not particularly limited. The ratio of the silicon element to all the elements included in the silicon particle may be, for example, not less than 50 mol %, not less than 70 mol %, or not less than 90 mol %.

In addition to Si element, the silicon particle may contain another element such as a Li element. Other elements include, in addition to Li element, Sn element, Fe element, Co element, Ni element, Ti element, Cr element, B element, P element, etc.

The silicon particles may contain impurities such as oxides.

The silicon particles may be amorphous or crystalline. The crystalline phase contained in the silicon particles is not particularly limited.

The shape and size of the silicon particles are not particularly limited. The mean particle diameter of the silicon particles may be, for example, 30 nm or more, 50 nm or more, 100 nm or more, or 150 nm or more, and may be 10 μm or less, 5 μm or less, 3 μm or less, 2 μm or less, or 1 μm or less. Note that the average particle diameter can be obtained by observing SEM or the like by an electronic microscope, and is obtained, for example, as an average of the largest ferret diameters of the plurality of particles. The number of samples is preferably large, for example, 20 or more, may be 50 or more, or may be 100 or more. The average particle diameter can be appropriately adjusted, for example, by appropriately changing the manufacturing conditions of silicon particles to be described later or by performing a classification process.

The silicon particles included in the surface-modified negative electrode active material particles may be porous silicon particles. The porous silicon particles include silicon having a plurality of voids. There is no particular limitation on the form of voids in the porous silicon particles.

The porous silicon particles may be particles comprising nanoporous silicon. Nanoporous silicon refers to silicon in which there are a plurality of pores having pore diameters on the order of nanometers (less than 1000 nm, preferably less than or equal to 100 nm).

### Fluoroalkyl Group

The surface-modified negative electrode active material particles of the present disclosure have a fluoroalkyl group that modifies the surface of the silicon particles.

The carbon number of the fluoroalkyl group may be 3 or more and 15 or less. The carbon number may be 4 or more, 5 or more, 6 or more, 7 or more, or 8 or more, and may be 14 or less, 13 or less, 12 or less, 11 or less, or 10 or less. The fluoroalkyl group may have a linear, branched, or cyclic structure, but is preferably a linear fluoroalkyl group. Alternatively, the fluoroalkyl group may be a perfluoroalkyl group or an alkyl group having part of hydrogen replaced with fluorine (e.g. —(CH₂)2(CF₂)ₙCF₃ (where n is an integer of 0 to 12)), but is preferably a fluoroalkyl group represented by —(CH₂)2(CF₂)ₙCF₃ (where n is an integer of 0 to 12).

The surface-modified negative electrode active material particles of the present disclosure may have a silicon-oxygen-silicon-carbon bond, silicon not bonded to the carbon may be silicon of the silicon particles, and carbon may be carbon of a fluoroalkyl group. That is, carbon of the fluoroalkyl group may be bonded to silicon on the surface of the silicon particles via oxygen and silicon.

### Method for Producing Surface-Modified Negative Electrode Active Material Particles

The method of the present disclosure for producing surface-modified negative electrode active material particles includes modifying the surface of the silicon particles with fluoroalkyl groups.

The surface of the silicon particle may be modified with a fluoroalkyl group by dehydration condensation of a silanol group on the surface of the silicon particle with a silanol group generated by hydrolyzing hydrolyzable group-containing silane having a fluoroalkyl group.

As the hydrolyzable group-containing silane, a hydrolyzable group-containing silane having a corresponding structure can be used with reference to the above description of the fluoroalkyl group of the present disclosure.

### Negative Electrode Mixture

The negative electrode mixture of the present disclosure includes surface-modified negative electrode active material particles and a fluorine-containing binder. The surface-modified negative electrode active material particles included in the negative electrode mixture of the present disclosure have silicon particles and a fluoroalkyl group that modifies the surface of the silicon particles.

Although not intending to be bound by any theory, it is considered that, by making the surface modifying group and the binder fluorine-based, the silicon particles and the binder are firmly bonded via the surface modifying group, and the peel strength in the negative electrode active material layer and the negative electrode current collector layer is improved, whereby the cracking of the negative electrode active material layer is suppressed, and as a result, the resistance is lowered.

In the context of the present disclosure, the “negative electrode mixture” means a composition capable of forming a negative active material layer as it is or by further containing other components. In the context of the present disclosure, the “negative electrode mixture slurry” means a slurry that includes a dispersion medium in addition to the “negative electrode mixture” and can be applied and dried thereby to form a negative electrode active material layer.

### Surface-Modified Negative Electrode Active Material Particle

The negative electrode mixture of the present disclosure includes surface-modified negative electrode active material particles. For the surface-modified negative electrode active material particles, reference can be made to the above description regarding the surface-modified negative electrode active material particles of the present disclosure.

### Fluorine-Containing Binder

The negative electrode mixture of the present disclosure includes a fluorine-containing binder. Examples of the fluorine-containing binder include a polyvinylidene fluoride (PVdF)-based binder and a polytetrafluoroethylene (PTFE)-based binder. The fluorine-containing binder is preferably a PVdF-based binder. The PVdF-based binder may be a copolymer having units derived from monomers other than VdF.

The negative electrode mixture of the present disclosure optionally includes a binder other than an electrolyte, a conductive aid, and a fluorine-containing binder.

### Electrolyte

The material of the solid electrolyte is not particularly limited, and a material that can be used as a solid electrolyte used in a lithium-ion battery can be used. For example, the solid electrolyte may be a sulfide solid electrolyte.

Examples of the sulfide solid electrolyte include, but are not limited to, a sulfide amorphous solid electrolyte, a sulfide crystalline solid electrolyte, or an argyrodite solid electrolyte. Specific examples of the sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

The sulfide solid electrolyte may be glass or crystallized glass (glass ceramic).

When the negative electrode mixture contains a solid electrolyte, the mass ratio of the surface-modified negative electrode active material particles to the solid electrolyte in the negative electrode mixture (mass of the surface-modified negative electrode active material particles: mass of the solid electrolyte) is preferably 85:15 to _{30:70}, and more preferably 80:20 to 40:60.

The electrolyte preferably contains a supporting salt and a solvent.

Examples of the supporting salt (lithium salt) in the lithium-ion conducting electrolyte include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃.

Examples of solvents used in the electrolyte include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). The electrolytic solution preferably contains two or more solvents.

### Conductive Aid

The conductive aid is not particularly limited. For example, the conductive aid may be, but is not limited to, Vapor Grown Carbon Fiber (VGCF) and acetylene black (AB), Ketjen black (KB), carbon nanotubes (CNT), carbon nanofibers (CNF), and the like. Binder other than fluorine-containing binder

The binder other than the fluorine-containing binder is not particularly limited. For example, the binder may be, but is not limited to, a material such as butadiene rubber (BR) or styrene butadiene rubber (SBR), or a combination thereof. The ratio of the mass of the binder other than the fluorine-containing binder to the total mass of the binder may be less than 50% by mass, less than 40% by mass, less than 30% by mass, less than 20% by mass, or less than 10% by mass, and may be 0% by mass.

### Lithium-Ion Battery

The lithium-ion battery of the present disclosure has a negative electrode active material layer, and the negative electrode active material layer contains the negative electrode mixture of the present disclosure. The lithium-ion battery of the present disclosure may include a negative electrode current collector layer, a negative electrode active material layer containing the negative electrode mixture of the present disclosure, a solid electrolyte layer, a positive electrode active material layer, and a positive electrode current collector layer in this order.

The lithium-ion battery of the present disclosure may be a liquid-based battery containing an electrolyte solution as an electrolyte layer, or may be a solid-state battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The lithium-ion battery may be a primary battery or a secondary battery.

The shape of the lithium-ion battery, for example, coin-type, laminate-type, cylindrical, square-type.

### Negative Electrode Current Collector Layer

The material used for the negative electrode current collector layer is not particularly limited, and a material that can be used as a negative electrode current collector of a battery may be appropriately employed, and for example, copper, a copper alloy, and a material obtained by plating or depositing nickel, chromium, carbon, and the like on copper may be used, but is not limited thereto.

The shape of the negative electrode current collector layer is not particularly limited, and may be, for example, a foil shape, a plate shape, or a mesh shape. Among the above, the foil shape is preferred.

### Negative Electrode Active Material Layer

The negative electrode active material layer of the present disclosure contains the negative electrode mixture of the present disclosure. Regarding the negative electrode mixture, the above description regarding the negative electrode mixture of the present disclosure can be referred to.

The thickness of the negative electrode active material layers is, for example, 0.1 μm to 1000 μm, preferably 1 μm to 100 μm, and more preferably 30 μm to 100 μm.

### Electrolyte Layer

The electrolyte layer contains at least an electrolyte. In addition, the electrolyte layer may contain a binder or the like as necessary in addition to the electrolyte. For the electrolyte, reference can be made to the above description of the negative electrode mixture of the present disclosure. The binder may be, for example, a material such as polyvinylidene fluoride (PVdF), butadiene rubber (BR), or styrene butadiene rubber (SBR), or a combination thereof, but is not limited thereto.

The thickness of the electrolyte layer is, for example, 0.1 to 300 μm, and preferably 0.1 to 100 μm.

### Positive Electrode Active Material Layer

The positive electrode active material layer is a layer containing a positive electrode active material, an optional electrolyte, a conductive aid, a binder, and the like.

The material of the positive electrode active material is not particularly limited. For example, the positive electrode active material may be, but is not limited to, lithium cobaltate (LiCoO₂), lithium nickelate (LiNiO₂), lithium manganate (LiMn₂O₄), LiCo_{1/3}Ni_{1/3}Mn_{1/3}O₂, different element-substituted Li—Mn spinel having a composition represented by Li₁₊ₓMn_{2-x-y}MyO₄ (where M is one or more metallic elements selected from Al, Mg, Co, Fe, Ni, and Zn), lithium titanate (LiₓTiO_{y}), lithium metal phosphate (LiMPO₄, where M is one or more metals selected from Fe, Mn, Co, and Ni), etc.

The positive electrode active material may have a coating layer. The coating layer is a layer containing a material having lithium ion conductivity, having low reactivity with a positive electrode active material or a solid electrolyte, and capable of maintaining a form of a coating layer that does not flow even when in contact with an active material or a solid electrolyte. Specific examples of the material of the coating layer include, but are not limited to, LiNbO₃, Li₄Ti₅O₁₂, and Li₃PO₄.

Examples of the shape of the positive electrode active material include particulate. The mean particle diameter (D50) of the positive electrode active material is not particularly limited, but may be, for example, 10 nm or more and 100 nm or more. Meanwhile, the mean particle diameter (D50) of the positive electrode active material is, for example, 50 μm or less, and may be 20 μm or less. The mean particle diameter (D50) can be calculated, for example, from measurements by means of a laser diffractometer, a scanning-electron-microscope (SEM).

Regarding the electrolyte and the conductive aid, the above description regarding the negative electrode mixture of the present disclosure can be referred to. For the binder, reference can be made to the above description of the electrolyte layer of the present disclosure.

When the positive electrode active material layer contains a solid electrolyte, the mass ratio of the positive electrode active material to the solid electrolyte in the positive electrode active material layer (mass of the positive electrode active material: mass of the solid electrolyte) is preferably 85:15 to 30:70, and more preferably 80:20 to 50:50.

The thickness of the positive electrode active material layers is, for example, 0.1 μm to 1000 μm, preferably 1 μm to 100 μm, and more preferably 30 μm to 100 μm.

### Positive Electrode Current Collector Layer

The material used for the positive electrode current collector layer is not particularly limited, and a material that can be used as a positive electrode current collector of a battery may be appropriately employed, and for example, a material such as SUS, nickel, chromium, gold, platinum, aluminum, iron, titanium, and zinc, and a material obtained by plating or depositing nickel, chromium, carbon, or the like on these metals may be used, but is not limited thereto.

The shape of the positive electrode current collector layer is not particularly limited, and may be, for example, a foil shape, a plate shape, or a mesh shape. Among the above, the foil shape is preferred.

Preparation of surface-modified negative electrode active material particles

### Preparation of Silicon Particles

### Comparative Synthesis Example 1

Silicon particles were prepared as a source of silicon (Si). The silicon particles and metallic lithium (Li) were weighed in a molar ratio of Li/Si=4.0 and the weighed silicon particles and Li were mixed in a mortar in an argon atmosphere to obtain a lithium silicon (LiSi) alloy. The resulting LiSi alloy was reacted with ethanol in an argon-atmosphere to obtain porous silicon particles.

Modification with a fluoroalkyl group

### Synthesis Example 1

2 g of porous silicon particles, 20 g of ultra-dehydrated ethanol (manufactured by Fujifilm Wako Pure Chemical Co., Ltd.), and 0.15 g of trimethoxy (1H, 1H, 2H, 2H-tridecafluoro-n-octyl) silane (manufactured by Tokyo Chemical Industry Co., Ltd.) that is a silane coupling agent having a fluoroalkyl group (—C₂H4(CF₂)₅CF₃) were weighed in an argon (Ar) substituted glove box, and were placed in a sealed reaction container. The mixture was stirred at 50°° C. for 16 hours to dehydrate and condense the silanol groups on the surface of the silicon particles and the silanol groups generated by hydrolysis of the silane coupling agent having a fluoroalkyl group. The solution was filtered by aspiration, washed with an ethanolic 30 mL, and filtered 5 times. The resulting solids were vacuum-dried at 100° C. for 12 hours to obtain surface-modified negative electrode active material particles in which the surface of the silicon particles was modified with —C₂H₄(CF₂)₅CF₃.

### Synthesis Example 2

Surface-modified negative electrode active material particles with the surfaces of silicon particles modified with —C₂H₄(CF₂)₇CF₃ were produced in the same manner as in Synthesis Example 1 except that the silane coupling agent was changed to 0.18 g of trimethoxy (1H, 1H, 2H, 2H-heptadecafluoprodecyl) silane having a fluoroalkyl group (—C₂H₄(CF₂)₇CF₃) (manufactured by Tokyo Chemical Industry Co., Ltd.).

### Comparative Synthesis Example 2

Surface-modified negative electrode active material particles with the surfaces of silicon particles modified with —(CH₂)₅CH₃ were produced in the same manner as in Synthesis Example 1 except that the silane coupling agent was changed to 0.06 g of hexyltrimethoxysilane (Tokyo Chemical Industry Co., Ltd) having an alkyl group (—(CH₂)₅CH₃), that is, having no fluoroalkyl group.

### Comparative Synthesis Example 3

Surface-modified negative electrode active material particles with the surfaces of silicon particles modified with —(CH₂)₇CH₃ were produced in the same manner as in Synthesis Example 1 except that the silane coupling agent was changed to 0.08 g of trimethoxy-n-octylsilane (manufactured by Tokyo Chemical Industry Co., Ltd.) having an alkyl group (—(CH₂)₇CH₃), that is, having no fluoroalkyl group.

### Production of Battery

### Preparation of Positive Electrode Mixture

Butyl butyrate, a 5 wt % butyl butyrate solution of a polyvinylidene fluoride (PVdF)-based binder, LiNi_{1/3}Co_{1/3}Mn_{1/3}O₂ (average particle size: 6 um) as a positive electrode active material, a Li₂S-P₂S₅-based glass ceramic as a sulfide solid electrolyte, and a vapor-grown carbon fiber (VGCF) as a conductive aid were placed in a polypropylene (PP) container, and the mixture was stirred for 30 seconds with an ultrasonic dispersion device (UH-50 manufactured by SMT CO., LTD.). Next, the container was shaken with a shaker (TTM-1, manufactured by Shibata Science Co., Ltd.) for 3 minutes, and stirred with the ultrasonic dispersion device for 30 seconds. Further, the mixture was shaken in a shaker for 3 minutes to obtain a slurry-like positive electrode mixture (positive electrode mixture slurry).

### Formation of Positive Electrode Active Material Layer

The resulting slurry was coated on an aluminum (Al) foil (manufactured by Showa Denko Co., Ltd.) as positive electrode current collector layers by a blade method using an applicator. The coated slurry was dried on a hot plate at 100° C. for 30 minutes. Thus, a positive electrode active material layer was formed on the positive electrode current collector layer.

### Preparation of Negative Electrode Mixture

### Comparative Examples 1 to 3 and Examples 1 and 2

Diisobutyl ketone, a 5 wt % diisoburyl ketone solution of a PVDF based binder (KF8300), VGCF as a conductive aid, Li₂S-P₂S₅-based glass ceramic as a solid electrolyte, any one of the silicon particles of Comparative Synthesis Examples 1 to 3 and Synthesis Examples 1 and 2 as a negative electrode active material were placed in a polypropylene (PP) container, and the mixture was stirred with an ultrasonic dispersion device (UH-50 manufactured by SMT) for 30 seconds. The container was then shaken with a shaker (manufactured by Shibata Science Co., Ltd., TTM-1) for 30 minutes to obtain a slurry-like negative electrode mixture (negative electrode mixture slurry) of Comparative Examples 1 to 3 and Examples 1 and 2.

### Comparative Examples 4 and 5

The negative electrode mixture slurries of Comparative Examples 4 and 5 were prepared in the same manner as in Examples 1 and 2, except that the binder was changed to a 5 wt % diisobutyl ketone solution of a styrene-butadiene rubber (SBR)-based binder.

### Formation of the Negative Electrode Active Material Layer

The resulting slurry was applied to a nickel (Ni) foil as a negative electrode current collector by a blade method using an applicator. The coated slurry was dried on a hot plate at 100°° C. for 30 minutes. Thus, a negative electrode active material layer was formed on the negative electrode current collector layer.

### Formation of Solid Electrolyte Layer

To a polypropylene (PP) container was added heptane, SBR based binder in 5 wt % heptane, and Li₂S-P₂S₅ based glass-ceramic as a solid electrolyte, and the mixture was stirred in an ultrasonic dispersion device (UH-50 manufactured by S. M. T.) for 30 seconds. Further, the container was shaken with a shaker (manufactured by Shibata Science Co., Ltd., TTM-1) for 30 minutes to obtain a solid-electrolyte slurry. The resulting slurry was applied to Al foil by a blade method using an applicator. The coated slurry was dried on a hot plate at 100° C. for 30 minutes. As a result, a solid electrolyte layer was formed. Three solid electrolyte layers were prepared.

### Battery Assembly

The positive electrode current collector layer, the positive electrode active material layer, and the first solid electrolyte layer were laminated in this order. The laminate was set in a roll press and pressed at 165° C. as a press pressure and 100 kN/cm as a press pressure in the first press step to obtain a positive electrode laminate.

The negative electrode current collector layer, the negative electrode active material layer, and the second solid electrolyte layer were laminated in this order. The laminate was set in a roll press and pressed at 25° C. as 60 kN/cm and pressing pressure in the second pressing step to obtain a negative electrode laminate.

The negative electrode laminate and the positive electrode laminate were prepared so that the area of the negative electrode laminate was larger than the area of the positive electrode laminate.

Further, an Al foil as a release sheet, an intermediate solid electrolyte layer formed on Al foil, and a negative electrode laminate were laminated so that the solid electrolyte layers were in contact with each other. The laminate was set in a flat uniaxial press, press-pressure 100 MPa, at a press-temperature of 25° C., was temporarily pressed for 10 seconds. Al foil was peeled from the intermediate solid electrolyte layer of the laminate to obtain a negative electrode laminate in which the intermediate solid electrolyte layer was further laminated.

The positive electrode laminate and the negative electrode laminate in which the intermediate solid electrolyte layer was further laminated were laminated so that the solid electrolyte layers were in contact with each other. The laminate was set in a planar uniaxial press and pressed for 1 minute at a pressing pressure 200 MPa and a pressing temperature of 120° C. in a third pressing step. Thus, an all-solid-state battery was obtained.

### Evaluation

### Analysis of Surface Properties of Silicon Particles

The carbon content of the silicon particles of the synthetic examples and the comparative synthetic examples was measured by a high-frequency burning infrared-absorbing method (used equipment: LECO Co., CSLS600). Further, the fluorine content of the silicon particles was measured by combustion ion chromatography (devices used: ICS-1500 ion chromatography manufactured by Thermo Fisher Scientific, and AQF-100 automated sample combustion device manufactured by Nitto Seiko Analytech Co., Ltd.).

In addition, the surface of the silicon particles was analyzed by X-ray photoelectron spectroscopy (XPS) (Instrument: PHI5000VersaprobeII, manufactured by ULVAC-PHI). X-ray source: AlKα, 15 kV, 3 mA energy-step: 0.1 eV, number of sweeps: 4 times. The peak area of XPS was obtained by subtracting a baseline from each peak using a XPS analysis software (MultiPak, manufactured by ULVAC-PHI Co., Ltd.) to obtain the integrated strength (area) of each peak. The area ratio of F(1s)/Si(2p) was calculated with the obtained area (F(107 eV from 692 eV, Si(2p):95 from 1s):684).

### Measurement of DCIR

The fabricated batteries were restrained at a predetermined restraining pressure using a restraining jig, and were charged at a constant current and a constant voltage to 4.55V at 1/10 C (1/100 C cut-off), and then discharged to 3.0V at 1 C. Thereafter, the batteries were charged at a constant current and a constant voltage to 4.35V at 1/3 C (1/100 C cut-off), and discharged at a constant current and a constant voltage to 3.00V at 1/3 C (1/100 C cut-off). The batteries were further charged at a constant current and a constant voltage to 4.35V at 1/3 C (1/100 C cut-off), and then discharged at a constant current and a constant voltage to 3.14V at 1/3 C (1/100 C cut-off). Thereafter, a 10 s current was applied at a 5 C constant current, and a direct-current-internal-resistance (DCIR) was measured.

### Results

### Analysis of Surface Properties of Silicon Particles

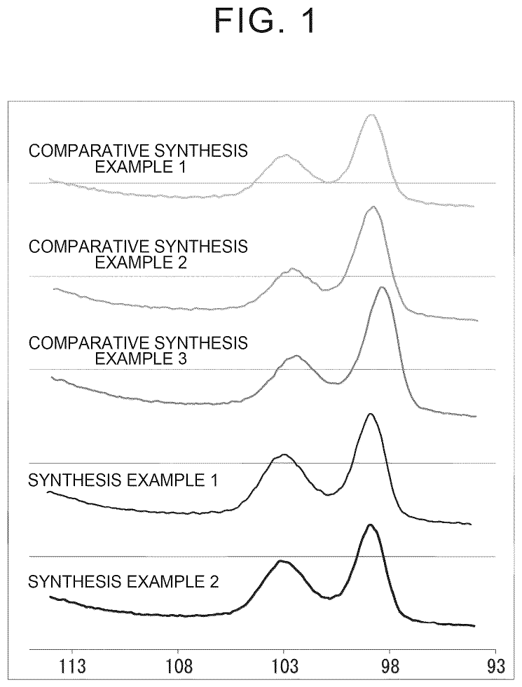

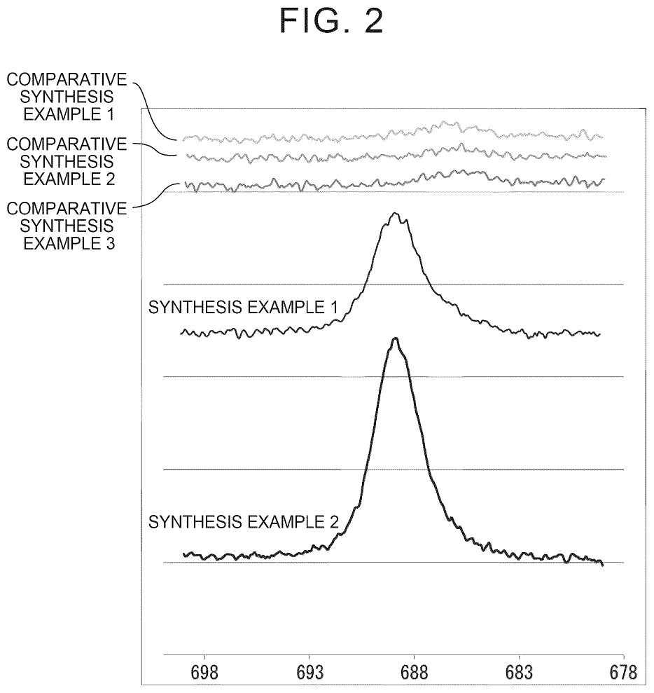

The results of quantitative analysis of the carbon content and the fluorine content of the silicon particles of the comparative synthesis example and the synthesis example are shown in Table 1. In addition, XPS of the silicon particles are shown in Tables and FIGS. 1 and 2.

TABLE 1

| | Surface modifying | Elemental content [wt %] | | F(1s)/ |
|---|---|---|---|---|
| | group | Carbon | Fluorine | Si(2p) |
| Comparative | — | 0.73 | 0.26 | 0.025 |
| Synthesis | | | | |
| Example 1 | | | | |
| Comparative | —(CH₂)₅CH₃ | 0.91 | 0.25 | 0.023 |
| Synthesis | | | | |
| Example 2 | | | | |
| Comparative | —(CH₂)₇CH₃ | 0.92 | 0.25 | 0.022 |
| Synthesis | | | | |
| Example 3 | | | | |
| Synthesis | —C₂H₄(CF₂)₅CF₃ | 0.91 | 0.33 | 0.16 |
| Example 1 | | | | |
| Synthetic | —C₂H₄(CF₂)₇CF₃ | 0.90 | 0.35 | 0.30 |
| Example 2 | | | | |

As shown in Table 1, the silicon particles of the synthesis example were larger in carbon content, fluorine content, and F(1s)/Si(2p) content on the particle surface than the silicon particles of the comparative synthesis example 1. From these facts, it is considered that the surface of the silicon particles of the examples could be modified with a fluoroalkyl group. In the silicon particles of Comparative Synthesis Examples 2 and 3, the carbon content of the particle surface was larger than that of the silicon particles of Comparative Synthesis Example 1, and therefore it is considered that the surface of these silicon particles could be modified with an alkyl group.

### Measurement of DCIR

Table 2 shows DCIR of the cells measured. The values of DCIR of the respective examples are expressed as relative values when the measured value of Comparative Example 1 is taken as 1.00.

TABLE 2

| | Surface modifying | | DCIR (Relative |
|---|---|---|---|
| | group | Binder | Value) |
| Comparative | — | PVdF-HFP | 1.00 |
| Example 1 | | | |
| Comparative | —(CH₂)₅CH₃ | PVdF-HFP | 1.05 |
| Example 2 | | | |
| Comparative | —(CH₂)₇CH₃ | PVdF-HFP | 1.04 |
| Example 3 | | | |
| Example 1 | —C₂H₄(CF₂)₅CF₃ | PVdF-HFP | 0.74 |
| Example 2 | —C₂H₄(CF₂)₇CF₃ | PVdF-HFP | 0.84 |
| Comparative | —C₂H₄(CF₂)₅CF₃ | SBR | 0.99 |
| Example 4 | | | |
| Comparative | —C₂H₄(CF₂)₇CF₃ | SBR | 1.03 |
| Example 5 | | | |

As shown in Tables 2, DCIR in the batteries of the embodiments in which both the surface-modifying group and the binder were fluorine-based were small. On the other hand, DCIR in the batteries of Comparative Examples 2 to 5 in which either the surface-modifying group or the binder was other than fluorine-based were the same as those in Comparative Example 1 in which the unmodified silicon particles were used.

What is claimed is:

1. A surface-modified negative electrode active material particle comprising:
a silicon particle; and
a fluoroalkyl group modifying a surface of the silicon particle.

2. The surface-modified negative electrode active material particle according to claim 1, wherein the surface-modified negative electrode active material particle includes a silicon-oxygen-silicon-carbon bond, the silicon not bonded to the carbon is silicon of the silicon particle, and the carbon is carbon of the fluoroalkyl group.

3. The surface-modified negative electrode active material particle according to claim 1, wherein a carbon number of the fluoroalkyl group is 3 or more and 12 or less.

4. A negative electrode mixture comprising:
the surface-modified negative electrode active material particle according to claim 1; and
a fluorine-containing binder.

5. The negative electrode mixture according to claim 4, wherein the fluorine-containing binder is a polyvinylidene fluoride-based binder.

6. A lithium-ion battery comprising a negative electrode active material layer, wherein the negative electrode active material layer contains the negative electrode mixture according to claim 4.

7. A method for producing a surface-modified negative electrode active material particle, the method comprising modifying a surface of a silicon particle with a fluoroalkyl group.

8. The method according to claim 7, wherein the surface of the silicon particle is modified with the fluoroalkyl group by dehydration condensation between a silanol group on the surface of the silicon particle and a silanol group generated by hydrolyzing hydrolyzable group-containing silane having a fluoroalkyl group.
